(19) United States
(12) Patent Application Publication
(10) Pub. No.: US 2023/0131094 A1
(43) Pub. Date: Apr. 27, 2023

(54) HEAT SEALING BARRIER LAMINATES INCLUDING POLYETHYLENE

(71) Applicant: Dow Global Technologies LLC, Midland, MI (US)

(72) Inventors: Hwee Lun Goh, Singapore (SG); Hwee Tatz Thai, Singapore (SG); Edward L. Lee, Singapore (SG); Wu Aik Yee, Singapore (SG)

(21) Appl. No.: 17/995,028

(22) PCT Filed: Apr. 26, 2021
(86) PCT No.: PCT/US2021/029056

§ 371 Date: Sep. 29, 2022

Related U.S. Application Data
(60) Provisional application No. 63/035,023, filed on Jun. 5, 2020.

(51) Int. Cl. B32B 27/08; B32B 27/30; B32B 27/32; B32B 7/12; B32B 7/02

(52) U.S. Cl. CPC B32B 27/08; B32B 27/306; B32B 27/32; B32B 7/12; B32B 7/02; B32B 2307/72; B32B 2307/518; B32B 2270/00; B32B 2307/732; B32B 2250/05; B32B 2250/24; B32B 2307/7244; B32B 2307/7246; B32B 2307/31; B32B 2307/734; B32B 2439/46; B32B 2439/70

(57) ABSTRACT

Provided are barrier laminates including polyethylene which offer heat resistance and a wide sealing window. The laminates can be fully compatible with polyethylene recycling streams and can exhibit improved, maintained, or desirable properties in comparison to existing laminate structures that are not fully compatible with polyethylene recycling streams. The laminate comprises a multilayer film, a polyethylene film, and an adhesive. The adhesive adheres the multilayer film to the polyethylene film to provide the laminate.

### TECHNICAL FIELD

Embodiments of the present disclosure generally relate to laminates, and more particularly relate to laminates including polyethylene.

### INTRODUCTION

Laminates that incorporate polypropylene, polyamide, and polyethylene terephthalate contain multiple layers and are widely used in flexible packaging for consumer products. For example, a typical laminate for flexible packaging can include an outer printing substrate of a biaxially oriented polypropylene (BOPP), a barrier layer of metalized films, an adhesive layer of solvent-based adhesive, and a sealant layer of polyethylene. The combination of layers and materials can allow for heat-resistance for a wide sealing window, good printability, high barrier performance, and sealing without shrinkage. But such laminates can be difficult, if not impossible, to recycle together due to the different types of materials that are not recycle-compatible with each other. As demand for sustainable and recyclable materials continues to rise, there remains a strong need for laminates that can be more easily recycled and that exhibit comparable or improved performance properties to existing structures.

### SUMMARY

Embodiments of the present disclosure meet the foregoing needs by providing laminates that can be fully recycle-compatible in polyethylene recycling streams. The performance of the inventive laminates can be better or at least comparable to other laminates, such as laminates comprising BOPP, and can allow for use of faster packaging speeds during manufacturing. For example, in certain aspects, the laminates can exhibit improved or maintained properties, such as barrier seal performance, oxygen transmission rate (OTR), water vapor transmission rate (WVTR), heat seal initiation temperatures (HSIT), heat seal strength, hot tack strength, hot tack initiation temperature, and/or shrinkage, when compared to existing laminates.

Disclosed herein is a laminate. In embodiments, the laminate comprises: (a) a multilayer film comprising: (1) a barrier layer comprising ethylene vinyl alcohol copolymer; (2) a sealant layer, wherein the sealant layer comprises at least 70 wt. % of an ionomer of ethylene acid copolymer or polyethylene elastomer/plastomer having a highest peak melting temperature (Tₘ) of 100° C. or less; and (3) a tie layer between the barrier layer and the sealant layer; (b) a polyethylene film comprising an ethylene-based polymer having a density from 0.900 to 0.970 g/cm³; and (c) an adhesive adhering the multilayer film to the polyethylene film.

These and other embodiments are described in more detail in the Detailed Description.

### BRIEF DESCRIPTION OF THE DRAWINGS

FIG. 1 is a heat seal strength graph of Comparative and Inventive Examples discussed below.

FIG. 2 is a hot tack strength graph of Comparative and Inventive Examples discussed below.

### DETAILED DESCRIPTION

Aspects of the disclosed laminates are described in more detail below. The laminates of the present disclosure can have a wide variety of applications, including, for example, pouches, stand-up pouches, pillow pouches, bulk bags, pre-made packages, sachets, or the like. This disclosure, however, should not be construed to limit the embodiments set forth below.

As used herein, the term “polymer” means a polymeric compound prepared by polymerizing monomers, whether of the same or a different type. The generic term polymer thus embraces the term homopolymer (employed to refer to polymers prepared from only one type of monomer), and the term copolymer or interpolymer. Trace amounts of impurities (for example, catalyst residues) may be incorporated into and/or within the polymer. A polymer may be a single polymer, a polymer blend, or a polymer mixture, including mixtures of polymers that are formed in situ during polymerization.

As used herein, the terms “polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); ethylene-based plastomers (POP) and ethylene-based elastomers (POE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy), and includes linear, substantially linear or heterogeneous polyethylene copolymers or homopolymers. LLDPEs contain less long chain branching than LDPEs and include the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy), and typically have a molecular weight distribution (“MWD”) greater than 2.5.

The term “HDPE” refers to polyethylenes having densities greater than about 0.935 g/cm³ and up to about 0.980 g/cm³, which are generally prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

The term “ULDPE” refers to polyethylenes having densities of 0.855 to 0.912 g/cm³, which are generally prepared with Ziegler-Natta catalysts, chrome catalysts, or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy). ULDPEs include, but are not limited to, polyethylene (ethylene-based) plastomers and polyethylene (ethylene-based) elastomers.

As used herein, the term “polyethylene elastomer/plastomer” shall mean a substantially linear, or linear, ethylene/α-olefin copolymer containing homogeneous short-chain branching distribution comprising units derived from ethylene and units derived from at least one C₃-C₁₀ α-olefin comonomer, or at least one C₄-C₈ α-olefin comonomer, or at least one C₆-C₈ α-olefin comonomer. Polyethylene elastomers/plastomers have a density from 0.865 g/cm³, or 0.870 g/cm³, or 0.880 g/cm³, or 0.890 g/cm³ to 0.900 g/cm³, or 0.902 g/cm³, or 0.904 g/cm³, or 0.909 g/cm³, or 0.910 g/cm³. Nonlimiting examples of polyethylene elastomers/plastomers include AFFINITY™ plastomers and elastomers (available from The Dow Chemical Company), EXACT™ plastomers (available from ExxonMobil Chemical), Tafmer (available from Mitsui), Nexlene™ (available from SK Chemicals Co.), and Lucene™ (available LG Chem Ltd.).

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

Multilayer Film of the Laminate

The laminate disclosed herein comprises a multilayer film. The multilayer film according to embodiments disclosed herein includes a barrier layer, a sealant layer, and a tie layer, where the tie layer is positioned between the barrier layer and the sealant layer. For example, the multilayer film according to embodiments disclosed herein can have a A/B/C structure, where A is the barrier layer, B is the tie layer, and C is the sealant layer. In further embodiments, the multilayer film further comprises an outer layer and a second tie layer, where the second tie layer is positioned between the outer layer and the barrier layer. For example, the multilayer film according to embodiments disclosed herein can have a A/B/C/D/E structure, where A is the outer layer, B is the second tie layer, C is the barrier layer, D is the tie layer, and E is the sealant layer. In such embodiments, the second tie layer, B, can have the same or different composition as the tie layer, D.

Barrier Layer of Multilayer Film

The multilayer film of the laminate comprises a barrier layer.

In embodiments, the barrier layer of the multilayer film can be positioned adjacent or in proximity to a tie layer described below and can be the outermost layer of the multilayer film. In other embodiments, an outer layer, as described below, is part of the multilayer film and is the outermost layer of the multilayer film, and a second tie layer, also described below, is positioned between the outer layer and the barrier layer. The barrier layer according to embodiments disclosed herein comprises an ethylene vinyl alcohol copolymer (EVOH).

In embodiments, the EVOH of the barrier layer has an ethylene content of from 20 to 50 mol %. All subranges and individual values of an ethylene content of from 20 to 50 mol % are disclosed and included herein. For example, in embodiments, the EVOH of the barrier layer has an ethylene content of from 20 to 50 mol %, or 22 to 45 mol %, or 25 to 40 mol %. A person of ordinary skill in the art will appreciate that the ethylene content of the EVOH can contribute to lower or higher OTR of the laminate disclosed herein (i.e., in general, the lower the ethylene content, the lower the achievable OTR value is). A person of ordinary skill in the art will also appreciate that a barrier layer comprising an EVOH with lower ethylene content may be suitable for flexible bottle and tube applications and a barrier layer comprising an EVOH with higher ethylene content may allow for easier processing, long-term run stability, and packaging types requiring flexibility (flex crack resistance), such as, thermoformability.

Commercially available examples of EVOH that can be used in the barrier layer include those commercially available from Kuraray Co., Ltd. (Tokyo, Japan) under the name EVAL™, including, for example, EVAL™ H171B (38 mol % ethylene content) and EVAL™ F171B (32 mol % ethylene content).

Various thicknesses are contemplated for the multilayer film. In embodiments, the barrier layer is 5 to 25% of the overall thickness of the multilayer film.

Sealant Layer of Multilayer Film

The multilayer film of the laminate comprises a sealant layer.

The sealant layer of the multilayer film comprises at least 70 wt. % of an ionomer of (meth)acrylic acid copolymer (referred herein also as an “ionomer of ethylene acid copolymer”) or a polyethylene elastomer/plastomer, based on the total weight of the sealant layer. All individual values and subranges of at least 70 wt. % are disclosed and included herein. For example, in embodiments, the sealant layer can comprise at least 70 wt. %, at least 80 wt. %, at least 90 wt. %, at least 95 wt. %, at least 99 wt. %, at least 99.5 wt. %, or from 70 wt. % to 100 wt. %, 75 wt. % to 99 wt. %, 80 wt. % to 95 wt. %, or 90 to 95 wt. % of an ionomer of ethylene acid copolymer or polyethylene elastomer/plastomer, based on the total weight of the sealant layer.

The sealant layer of the multilayer film comprises at least 70 wt. % of an ionomer of ethylene acid copolymer or polyethylene elastomer/plastomer having a highest peak melting temperature (Tₘ) of 100° C. or less. All individual values and subranges of 100° C. or less are disclosed and included herein. For example, in embodiments, the ionomer of ethylene acid copolymer or the polyethylene elastomer/plastomer of the sealant layer has a highest peak melting temperature (Tₘ) of 100° C. or less, 98° C. or less, 96° C. or less, 94° C. or less, or 92° C. or less, or in the range of from 70° C. to 100° C., 70° C. to 95° C., 75° C. to 100° C., or 75° C. to 95° C., where highest peak melting temperature (Tₘ) can be measured in accordance with the DSC test method described below.

In embodiments, the sealant layer comprises at least 70 wt. % of a polyethylene elastomer/plastomer that has a highest peak melting temperature (Tₘ) of 100° C. or less. In such embodiments, the polyethylene elastomer/plastomer of the sealant layer can have a density in the range of from 0.865 to 0.910 g/cm³. All individual values and subranges of a density of from 0.865 to 0.910 g/cm³ are disclosed and included herein; for example, the polyethylene elastomer/plastomer can have a density in the range of from 0.865 to 0.910 g/cm³, 0.865 to 0.900 g/cm³, 0.865 to 0.890 g/cm³, 0.865 to 0.880 g/cm³, 0.865 to 0.870 g/cm³, 0.870 to 0.910 g/cm³, 0.870 to 0.900 g/cm³, 0.870 to 0.890 g/cm³, 0.870 to 0.880 g/cm³, 0.880 to 0.910 g/cm³, 0.880 to 0.900 g/cm³, 0.880 to 0.890 g/cm³, 0.890 to 0.910 g/cm³, 0.890 to 0.900 g/cm³, or 0.900 to 0.910 g/cm³.

In embodiments where the sealant layer comprises a polyethylene elastomer/plastomer, the polyethylene elastomer/plastomer can have a melt index (I₂) in the range of from 0.50 to 20 g/10 minutes (g/10 min). All individual values and subranges of a melt index (I₂) of from 0.50 to 20 g/10 min are disclosed and include herein; for example, the polyethylene elastomer/plastomer can have a melt index (I₂) of a lower limit of 0.50, 1.0, 2.0, 5.0, 10.0, 15, or 18 g/10 min to an upper limit of 1.0, 2.0, 5.0, 10.0, 15, 18, 19, or 20 g/10 min.

Commercially available examples of polyethylene elastomers/plastomers that can be used in the sealant layer include those commercially available from The Dow Chemical Company (Midland, Mich.) under the name AFFINITY™ including, for example, AFFINITY™ VP 8770G1, AFFINITY™ PF7266, AFFINITY™ PL 1881G and AFFINITY™ PF1140G.

In embodiments, the sealant layer comprises an ionomer of ethylene acid copolymer that has a highest peak melting temperature (Tₘ) of 100° C. or less. The cation source of the ionomer of ethylene acid copolymer may be a mono- or divalent cation source, including formates, acetates, hydroxides, nitrates, carbonates, and bicarbonates. In embodiments, the ionomer of ethylene acid copolymer may have been treated with one or more cations or cation sources which may comprises magnesium, sodium, zinc, or combinations thereof.

In embodiments, the ethylene content of the ionomer of ethylene acid copolymer is greater than 50 wt. %, or greater than 60 wt. %, based on the total weight of the ionomer of ethylene acid copolymer. For example, the ethylene content of the ionomer of ethylene acid copolymer can be from 50 wt. % to 95 wt. %, from 50 wt. % to 90 wt. %, from 50 wt. % to 85 wt. %, or from 60 wt. % to 80 wt. %, based on total weight of the ionomer of ethylene acid copolymer.

In embodiments, the ionomer of ethylene acid copolymer has a melt index (I₂) of from 0.1 g/10 min to 16 g/10 min, from 3 g/10 min to 13 g/10 min, from 3.5 g/10 min to 10 g/10 min, or from 5 g/10 min to 8 g/10 min. Commercially available ionomers of ethylene acid copolymer include those available under the name SURLYN™ from The Dow Chemical Company (Midland, Mich.).

In addition to an ionomer of ethylene acid copolymer or polyethylene elastomer/plastomer, the sealant layer, in embodiments, can further comprise at least one additional polymer and/or at least one additive. For example, the at least one additional polymer can be selected from the group of a polyethylene, ethylene vinyl acetate, ethylene acrylic acid, or combinations thereof in an amount of less than 30 wt. % of the sealant layer. And for example, the at least one additive can be selected from the group of antioxidants, ultraviolet light stabilizers, thermal stabilizers, slip agents, antiblock agent, antistatic agents, pigments or colorants, processing aids, crosslinking catalysts, flame retardants, fillers, foaming agents, or combinations thereof in an amount of less than 30 wt. % of the sealant layer.

In embodiments, the sealant layer further comprises a polyethylene that has a highest peak melting temperature (Tₘ) of 108° C. or less. For example, in embodiments, the sealant layer further comprises a linear low density polyethylene (LLDPE). The linear low density polyethylene can have a density less than or equal to 0.930 g/cm³. All individual values and subranges of less than or equal to 0.930 g/cm³ are included and disclosed herein; for example, the density of the linear low density polyethylene can be from a lower limit of 0.870 g/cm³ to an upper limit of 0.928, 0.925, 0.920 or 0.915 g/cm³. All individual values and subranges between 0.870 and 0.930 g/cm³ are included and disclosed herein.

Commercially available examples of polyethylenes having a highest peak melting temperature (Tₘ) of 108° C. or less that can be used in the sealant layer include those commercially available from The Dow Chemical Company under the name ELITE™ AT including, for example, ELITE™ AT 6202 and ELITE™ AT 6410.

In embodiments, the sealant layer is at least 10 microns thick, or alternatively at least 15 microns thick, or alternatively at least 20 microns thick. In further embodiments, the sealant layer is 25 to 60% of the overall thickness of the multilayer film.

Tie Layer of Multilayer Film

The multilayer film of the laminate comprises a tie layer between the barrier layer and the sealant layer. The tie layer can adhere the barrier layer to the sealant layer.

In embodiments, the tie layer comprises an adhesive resin selected from the group consisting of anhydride grafted ethylene-based polymer, ethylene acid copolymer, and ethylene vinyl acetate. Examples of anhydride grafting moieties may include but are not limited to, maleic anhydride, citraconic anhydride, 2-methyl maleic anhydride, 2-chloromaleic anhydride, 2,3-dimethylmaleic anhydride, bicyclo[2,2,1]-5-heptene-2,3-dicarboxylic anhydride and 4-methyl-4-cyclohexene-1,2-dicarboxylic anhydride, bicyclo(2.2.2)oct-5-ene-2,3-dicarboxylic acid anhydride, lo-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, tetrahydrophthalic anhydride, norborn-5-ene-2,3-dicarboxylic acid anhydride, nadic anhydride, methyl nadic anhydride, himic anhydride, methyl himic anhydride, and x-methyl-bi-cyclo(2.2.1)hept-5-ene-2,3-dicarboxylic acid anhydride. In one embodiment, the anhydride grafting moiety comprises maleic anhydride.

In embodiments, the tie layer comprises an anhydride-modified, linear low density polyethylene. In embodiments, the anhydride-modified, linear low density polyethylene has a density in the range of from 0.860 g/cm³ to 0.935 g/cm³. All individual values and subranges of from 0.860 g/cm³ to 0.935 g/cm³ are disclosed and included herein; for example, the anhydride-modified, linear low density polyethylene can have a density in the range of from 0.875 g/cm³ to 0.935 g/cm³, 0.900 g/cm³ to 0.925 g/cm³, 0.910 g/cm³ to 0.935 g/cm³, 0.910 g/cm³ to 0.925 g/cm³, 0.915 g/cm³ to 0.935 g/cm³, or 0.920 g/cm³ to 0.930 g/cm³. In embodiments, the anhydride-modified, linear low density polyethylene has a melt index (I₂) from 0.1 g/10 min to 50 g/10 min, or from 0.5 g/10 min to 20 g/10 min, or from 1.0 g/10 min to 10 g/10 min.

In embodiments, the tie layer comprises from 0 to 100 wt. % of the anhydride-modified, linear low density polyethylene, based on the total weight of the tie layer. All individual values and subranges of from 0 to 100 wt. % are disclosed and included herein. For example, in embodiments, the tie layer can comprise from 10 to 90 wt. %, 20 to 80 wt. %, 30 to 70 wt. %, or 40 to 60 wt. % of the anhydride-modified, linear low density polyethylene, based on the total weight of the tie layer.

Examples of commercially available anhydride-modified, linear low density polyethylenes that can be used in embodiments include BYNEL™ Series 4100 resins, such as BYNEL™ 41E710 and BYNEL™ 41E687, available from The Dow Chemical Company (Midland, Mich.).

In embodiments, the tie layer further comprises at least one of a linear low density polyethylene, low density polyethylene, medium density polyethylene, or high density polyethylene. For example, in embodiments, the tie layer further comprises a high density polyethylene having a density in the range of from 0.945 g/cm³ to 0.970 g/cm³. All individual values and subranges of from 0.945 g/cm³ to 0.970 g/cm³ are disclosed and included herein; for example, the high density polyethylene can have a density in the range of from 0.945 g/cm³ to 0.965 g/cm³, 0.950 g/cm³ to 0.970 g/cm³, 0.950 g/cm³ to 0.965 g/cm³, 0.955 g/cm³ to 0.970 g/cm³, 0.955 g/cm³ to 0.965 g/cm³, or 0.955 g/cm³ to 0.965 g/cm³.

In embodiments where a high density polyethylene is present, the high density polyethylene of the tie layer can be a copolymer of ethylene and C₃-C₁₂ comonomer. In embodiments, the tie layer further comprises from 0 to 90 wt. % of a high density polyethylene, based on the total weight of the tie layer. All individual values and subranges of from 0 to 90 wt. % are disclosed and included herein. For example, in embodiments, the tie layer can comprise from 10 to 90 wt. %, 20 to 80 wt. %, 30 to 70 wt. %, or 40 to 60 wt. % of a high density polyethylene, based on the total weight of the tie layer. In embodiments, the melt index (I₂) of the high density polyethylene can be from 0.3 to 10.0 g/10 min, from 0.3 to 7.0 g/10 min, from 0.3 to 5.0 g/10 min, from 0.3 to 4.0 g/10 min, from 0.3 to 3.0 g/10 min, from 0.3 to 2.0 g/10 min or from 0.3 to 1.5 g/10 min, or from 0.5 to 1.0 g/10 min.

Commercially available examples of high density polyethylene that can be used in the tie layer include those commercially available from The Dow Chemical Company (Midland, Mich.) under the name ELITE™ 5960G1 and DOWLEX™ 2006G.

Outer and Second Tie Layer of Multilayer Film

In embodiments, the multilayer film can comprise an outer layer and a second tie layer, where the second tie layer is positioned between the outer layer and the barrier layer.

According to embodiments disclosed herein, the outer layer of the multilayer film comprises a polyethylene. In embodiments, the polyethylene of the outer layer has a density from 0.900 to 0.970 g/cm³. All individual values and subranges of from 0.900 to 0.970 g/cm³ are disclosed and included herein. For example, the polyethylene can have a density of from 0.900 to 0.970 g/cm³, 0.910 to 0.957 g/cm³, 0.920 to 0.947 g/cm³, 0.920 to 0.937 g/cm³, 0.920 to 0.930 g/cm³, or 0.920 to 0.927 g/cm³.

In embodiments, the polyethylene of the outer layer has a melt index of from 0.1 g/10 min to 10 g/10 min, or from 0.5 g/10 min to 8 g/10 min, or from 0.5 g/10 min to 5 g/10 min.

In embodiments, the polyethylene of the outer layer comprises at least 50 wt. % of the outer layer, based on the total weight of the outer layer. All individual values and subranges of at least 50 wt. % are disclosed and included herein. For example, the polyethylene can comprise at least 50 wt. %, at least 75 wt. %, at least 90 wt. %, at least 99 wt. %, or at least 99.9 wt. % of the outer layer, based on the total weight of the outer layer.

In addition to a polyethylene, the outer layer, in embodiments, can further comprise at least one additional polymer, and the at least one additional polymer can be selected from the group of ultra low density polyethylene, low density polyethylene, polyethylene elastomer/plastomer, ethylene vinyl acetate, ethylene acrylic acid, or combinations thereof in an amount of less than 50 wt. % of the outer layer.

In embodiments, the multilayer film further comprises a second tie layer between the outer layer and the barrier layer. The second tie layer can adhere the outer layer to the barrier layer.

In embodiments, the second tie layer comprises an adhesive resin selected from the group consisting of anhydride grafted ethylene-based polymer, ethylene acid copolymer, and ethylene vinyl acetate. Examples of anhydride grafting moieties may include but are not limited to, maleic anhydride, citraconic anhydride, 2-methyl maleic anhydride, 2-chloromaleic anhydride, 2,3-dimethylmaleic anhydride, bicyclo[2,2,1]-5-heptene-2,3-dicarboxylic anhydride and 4-methyl-4-cyclohexene-1,2-dicarboxylic anhydride, bicyclo(2.2.2)oct-5-ene-2,3-dicarboxylic acid anhydride, lo-octahydronaphthalene-2,3-dicarboxylic acid anhydride, 2-oxa-1,3-diketospiro(4.4)non-7-ene, bicyclo(2.2.1)hept-5-ene-2,3-dicarboxylic acid anhydride, tetrahydrophthalic anhydride, norborn-5-ene-2,3-dicarboxylic acid anhydride, nadic anhydride, methyl nadic anhydride, himic anhydride, methyl himic anhydride, and x-methyl-bi-cyclo(2.2.1)hept-5-ene-2,3-dicarboxylic acid anhydride. In one embodiment, the anhydride grafting moiety comprises maleic anhydride.

In embodiments, the second tie layer comprises an anhydride-modified, linear low density polyethylene. In embodiments, the anhydride-modified, linear low density polyethylene has a density in the range of from 0.860 g/cm³ to 0.935 g/cm³. All individual values and subranges of from 0.860 g/cm³ to 0.935 g/cm³ are disclosed and included herein; for example, the anhydride-modified, linear low density polyethylene can have a density in the range of from 0.875 g/cm³ to 0.935 g/cm³, 0.900 g/cm³ to 0.925 g/cm³, 0.910 g/cm³ to 0.935 g/cm³, 0.910 g/cm³ to 0.925 g/cm³, 0.915 g/cm³ to 0.935 g/cm³, or 0.920 g/cm³ to 0.930 g/cm³. In embodiments, the anhydride-modified, linear low density polyethylene has a melt index (I2) from 0.1 g/10 min to 50 g/10 min, or from 0.5 g/10 min to 20 g/10 min, or from 1.0 g/10 min to 10 g/10 min.

In embodiments, the second tie layer comprises from 0 to 100 wt. % of the anhydride-modified, linear low density polyethylene, based on the total weight of the second tie layer. All individual values and subranges of from 0 to 100 wt. % are disclosed and included herein. For example, in embodiments, the second tie layer can comprise from 10 to 90 wt. %, 20 to 80 wt. %, 30 to 70 wt. %, or 40 to 60 wt. % of the anhydride-modified, linear low density polyethylene, based on the total weight of the second tie layer.

Examples of commercially available anhydride-modified, linear low density polyethylenes that can be used in embodiments include BYNEL™ Series 4100 resins, such as BYNEL™ 41E710 and BYNEL™ 41E687, available from The Dow Chemical Company (Midland, Mich.).

In embodiments, the second tie layer further comprises at least one of a linear low density polyethylene, low density polyethylene, medium density polyethylene, or high density polyethylene. For example, in embodiments, the second tie layer further comprises a high density polyethylene having a density in the range of from 0.945 g/cm³ to 0.970 g/cm³. All individual values and subranges of from 0.945 g/cm³ to 0.970 g/cm³ are disclosed and included herein; for example, the high density polyethylene of the second tie layer can have a density in the range of from 0.945 g/cm³ to 0.965 g/cm³, 0.950 g/cm³ to 0.970 g/cm³, 0.950 g/cm³ to 0.965 g/cm³, 0.955 g/cm³ to 0.970 g/cm³, 0.955 g/cm³ to 0.965 g/cm³, or 0.955 g/cm³ to 0.965 g/cm³.

In embodiments where a high density polyethylene is present, the high density polyethylene of the second tie layer can be a copolymer of ethylene and C₃-C₁₂ comonomer. In embodiments, the second tie layer comprises from 0 to 90 wt. % of a high density polyethylene, based on the total weight of the second tie layer. All individual values and subranges of from 0 to 90 wt. % are disclosed and included herein. For example, in embodiments, the second tie layer can comprise from 10 to 90 wt. %, 20 to 80 wt. %, 30 to 70 wt. %, or 40 to 60 wt. % of a high density polyethylene, based on the total weight of the second tie layer. In embodiments, the high density polyethylene of the second tie layer can have a melt index (I₂) from 0.3 to 10.0 g/10 min, from 0.3 to 7.0 g/10 min, from 0.3 to 5.0 g/10 min, from 0.3 to 4.0 g/10 min, from 0.3 to 3.0 g/10 min, from 0.3 to 2.0 g/10 min or from 0.3 to 1.5 g/10 min, or from 0.5 to 1.0 g/10 min.

Commercially available examples of high density polyethylene that can be used in the second tie layer include those commercially available from The Dow Chemical Company (Midland, Mich.) under the name ELITET™ 5960G1 and DOWLEX™ 2006G.

Adhesive

The laminate comprises an adhesive adhering the multilayer film described above to the polyethylene film described below. The adhesive can be applied to the outermost layer of the multilayer film (e.g., the barrier layer in embodiments or the outer layer in other embodiments) to act as an adhesive layer and adhere the multilayer film to the polyethylene film described below.

In embodiments, the adhesive is a solvent based adhesive, solvent-free adhesive, or water-borne adhesive. Examples of commercially available adhesives that can be used in embodiments include those available from The Dow Chemical Company (Midland, Mich.) under the names ADCOTE™, MOR-FREE™, and ROBOND™.

Polyethylene Film of the Laminate

The laminate disclosed herein comprises a polyethylene film. The polyethylene film according to embodiments disclosed herein adheres to the barrier layer or outer layer of the multilayer film via the adhesive describe above. The polyethylene film comprises an ethylene-based polymer having a density from 0.900 to 0.970 g/cm³.

In embodiments, the ethylene-based polymer of the polyethylene film has a density from 0.900 to 0.970 g/cm³. All individual values and subranges of from 0.900 to 0.970 g/cm³ are disclosed and included herein. For example, the ethylene-based polymer can have a density of from 0.900 to 0.970 g/cm³, 0.910 to 0.957 g/cm³, 0.920 to 0.947 g/cm³, 0.920 to 0.937 g/cm³, 0.920 to 0.930 g/cm³, or 0.920 to 0.927 g/cm³.

In embodiments, the ethylene-based polymer has a melt index (I₂) of from 0.1 g/10 min to 10 g/10 min, or from 0.5 g/10 min to 8 g/10 min, or from 0.5 g/10 min to 5 g/10 min.

In embodiments, the ethylene-based polymer comprises at least 50 wt. % of the polyethylene film, based on the total weight of the polyethylene film. All individual values and subranges of at least 50 wt. % are disclosed and included herein. For example, the ethylene-based polymer can comprise at least 50 wt. %, at least 75 wt. %, at least 90 wt. %, at least 99 wt. %, or at least 99.9 wt. % of the polyethylene film, based on the total weight of the polyethylene film.

In addition to the ethylene-based polymer, the polyethylene film, in embodiments, can further comprise at least one additional polymer, and the at least one additional polymer can be selected from the group of a second ethylene-based polymer, polyethylene elastomer/plastomer, ethylene vinyl acetate, ethylene acrylic acid, or combinations thereof. For example, the polyethylene film can further comprise at least 20 wt. % of a second ethylene-based polymer having a density of 0.958 g/cm³ or greater.

The polyethylene film can be a multilayer or monolayer film. In embodiments, the polyethylene film is a monolayer film. In other embodiments, the polyethylene film comprises at least two layers. Embodiments of the polyethylene film can include ties layer, sealant layers, or barrier layers, for example. In embodiments, the polyethylene film further comprises a barrier layer comprising an ethylene vinyl alcohol copolymer (EVOH).

In embodiments, the polyethylene film is an oriented film. In embodiments, the polyethylene film is a machine direction oriented film. In such embodiments, the polyethylene film can be a machine direction oriented (MDO) polyethylene film. In other embodiments, the polyethylene films is biaxially oriented. In such embodiments, the polyethylene film can be a biaxially oriented polyethylene (BOPE) film. In embodiments in which the polyethylene film is a BOPE, the BOPE may be biaxially oriented using a tenter frame sequential biaxial orientation process, and may referred to as tenter frame biaxially oriented polyethylene (TF-BOPE). Such techniques are generally known to those of skill in the art. In other embodiments, the polyethylene film can be biaxially oriented using other techniques known to those of skill in the art based on the teachings herein, such as a double bubble orientation process. In general, with a tenter frame sequential biaxial orientation process, the tenter frame is incorporated as part of a multilayer co-extrusion line. After extruding from a flat die, the film is cooled down on a chill roll, and is immersed into a water bath filled with room temperature water. The cast film is then passed onto a series of rollers with different revolving speeds to achieve stretching in the machine direction. There are several pairs of rollers in the MD stretching segment of the fabrication line, and are all oil heated. The paired rollers work sequentially as pre-heated rollers, stretching rollers, and rollers for relaxing and annealing. The temperature of each pair of rollers is separately controlled. After stretching in the machine direction, the film web is passed into a tenter frame hot air oven with heating zones to carry out stretching in the cross direction. The first several zones are for pre-heating, followed by zones for stretching, and then the last zones for annealing.

In embodiments, the polyethylene film has a cross directional draw ratio larger than its machine direction draw ratio, and the polyethylene film has a ratio of percent elongation at break in the machine direction to percent elongation at break in the cross direction of at least 2 to 1. In embodiments, the polyethylene film can exhibit a percent elongation at break in the machine direction that is at least 2 times greater than the percent elongation at break in the cross direction when measured according to ASTM D882, or in the alternative, at least 5 times greater, or in the alternative, at least 8 times greater, or in the alternative, at least 10 times greater.

In embodiments, the polyethylene film can be oriented in the machine direction at a draw ratio of 2:1 to 6:1, or in the alternative, at a draw ratio of 3:1 to 5:1. The polyethylene film, in embodiments, can be oriented in the cross direction at a draw ratio of 2:1 to 9:1, or in the alternative, at a draw ratio of 3:1 to 8:1. In embodiments, the polyethylene film is oriented in the machine direction at a draw ratio of 2:1 to 6:1 and in the cross direction at a draw ratio of 2:1 to 9:1.

In embodiments, depending for example on the end use application, the polyethylene film can be corona treated or printed using techniques known to those of skill in the art before or after being adhered to the multilayer film.

The multilayer film and the polyethylene film disclosed herein can have a variety of thicknesses depending, for example, on the number of layers. For example, in embodiments, the multilayer film or the polyethylene film can have a thickness of from 10 to 200 microns, or alternatively, of from 15 to 100 microns.

Additives

It should be understood that any of the foregoing layers of the multilayer film or polyethylene film can further comprise one or more additives as known to those of skill in the art such as, for example, antioxidants, ultraviolet light stabilizers, thermal stabilizers, slip agents, antiblock agent, antistatic agents, pigments or colorants, processing aids, crosslinking catalysts, flame retardants, fillers and foaming agents. For example, in embodiments, the sealant layer of the multilayer film comprises at least one of a slip agent or antiblock agent.

The Laminate

As noted above, the polyethylene film is adhered to the outermost layer (e.g., the barrier layer in embodiments or the outer layer in other embodiments) of the multilayer film, and the combination of the multilayer film and the polyethylene film provides the laminate.

The laminate of the present invention can have several desirable properties. For example, the laminate of the present invention can have one or more of the following properties: an OTR of less than 6.75 cm³/day/m²; a WVTR of less than 4.50 g/day/m²; a heat seal initiation temperature at 5N of less than 97° C.; a seal strength at 120° C. of at least 10.0 N/25 mm; a hot tack initiation at 1N of less than 83° C.; a hot tack strength at 110° C. of at least 0.30 N; and zero percent (0%) shrinkage at a temperature range of from 70° C. to at least 110° C.

In embodiments, the laminate has a sealing window of at least 40° C.

In embodiments, the laminate of the present invention comprises at least 90 wt. % polyethylene, or at least 95 wt. % polyethylene, or at least 99 wt. % polyethylene, or at least 99.5 wt. % polyethylene, or at least 99.9 wt. % polyethylene, based on the overall weight of the laminate.

Articles

Embodiments of the present invention also provide articles formed from the laminate described herein. Examples of such articles can include packages, flexible packages, and pouches. In embodiments, packages of the present invention can comprise a liquid, a powder, a food product, or other items. Articles and packages of the present invention can be formed from the laminate disclosed herein using techniques known to those of skill in the art in view of the teachings herein.

Test Methods

Density

Density is measured in accordance with ASTM D792, and expressed in grams/cm³ (g/cm³).

Melt Index (I₂)

Melt index (I₂) is measured in accordance with ASTM D-1238 at 190° C. at 2.16 kg. The values are reported in g/10 min, which corresponds to grams eluted per 10 minutes.

Oxygen Transmission Rate (OTR)

Oxygen transmission rate (OTR) is measured in accordance with ASTM D3985. Samples are tested at 23° C., 0% RH, 50 cm² sample size. The values are reported in cm³/day/m².

Water Vapor Transmission Rate (WVTR)

Water Vapor Transmission Rate (WVTR) is measured in accordance with ASTM F1249. Samples are tested at 37.8° C., 100% RH, and 50 cm² sample size. The values are reported in g/day/m².

Hot Tack Initiation and Hot Tack Strength

A hot tack test is performed using a J&B hot tack tester 4000 at sealing width of 25 mm, dwell seal time of 0.5 s, sealing pressure of 0.275 N/mm² (40 psi), and hot tack pull speed of 200 mm/s. Hot tack initiation is reported as a minimum temperature in degrees Celsius to reach 1 Newton force. Hot tack strength is measured in units of Newton per 25 mm (N/25 mm).

Heat Seal Initiation Temperature and Seal Strength

To determine heat seal initiation temperature (HSIT) and seal strength, samples are sealed by a J&B Hot Tack 4000 Tester. The sample width is 25 mm, the dwell seal time is 0.5 seconds, and the seal pressure is 0.275 N/mm². Heat sealed samples are conditioned for 24 hours and then measured using a Zwick tensile machine, equipped with a 200 N load cell, and at a pulling speed of 500 mm/min. HSIT is reported as a minimum temperature in degrees Celsius to reach 5 Newton force. Seal Strength values are reported in N/25 mm.

Shrinkage

Shrinkage (%) is obtained by measuring the length and width of the seal area in both MD and TD directions after heat sealing the films together and calculating the percentage of change compared to the seal bar width, which can be between 1 mm to 15 mm. Standard heat sealing machines, including PULSA impulse sealer or J&B Hot Tack tester can be used, provided the machines have an accurate and adjustable temperature controller. Sealing conditions include jaw pressure (40-80 psi or 0.275-0.552 N/mm²), dwell time (0.1-1.5 seconds), and seal temperature (60-150° C.) window and depend on packaging speed, where typical conditions for fast speed packaging machines are 40 psi (0.275 N/mm²) jaw pressure and 0.5 seconds dwell time.

Highest Peak Melting Temperature (Tm)

Differential Scanning Calorimetry (DSC) is used to measure the melting and crystallization behavior of a polymer over a wide range of temperatures. For example, the TA Instruments Q1000 DSC, equipped with an RCS (refrigerated cooling system) and an autosampler is used to perform this analysis. The instrument is first calibrated using the software calibration wizard. A baseline is obtained by heating a cell from −80° C. to 280° C. without any sample in an aluminum DSC pan. Sapphire standards are then used as instructed by the calibration wizard. Next, 1 to 2 milligrams (mg) of a fresh indium sample are analyzed by heating the standards sample to 180° C., cooling to 120° C. at a cooling rate of 10° C./minute, and then keeping the standards sample isothermally at 120° C. for 1 minute. The standards sample is then heated from 120° C. to 180° C. at a heating rate of 10° C./minute. Then, it is determined that indium standards sample has heat of fusion (H_{f})=28.71±0.50 Joules per gram (J/g) and onset of melting=156.6° C.±0.5° C. Test samples are then analyzed on the DSC instrument.

During testing, a nitrogen purge gas flow of 50 ml/min is used. Each sample is melt pressed into a thin film at about 175° C.; the melted sample is then air-cooled to room temperature (approx. 25° C.). The film sample is formed by pressing a “0.1 to 0.2 gram” sample at 175° C. at 1,500 psi, and 30 seconds, to form a “0.1 to 0.2 mil thick” film. A 3-10 mg, 6 mm diameter specimen is extracted from the cooled polymer, weighed, placed in a light aluminum pan (ca 50 mg), and crimped shut. Analysis is then performed to determine its thermal properties.

The thermal behavior of the sample is determined by ramping the sample temperature up and down to create a heat flow versus temperature profile. First, the sample is rapidly heated to 180° C., and held isothermal for five minutes, in order to remove its thermal history. Next, the sample is cooled to −40° C., at a 10° C./minute cooling rate, and held isothermal at −40° C. for five minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The values determined are highest peak melting temperature (Tₘ), peak crystallization temperature (T_{c}), onset crystallization temperature (Tc onset), heat of fusion (H_{f}) (in Joules per gram), and the calculated % crystallinity for polyethylene samples using: % Crystallinity for PE=((Hf)/(292 J/g))×100, and the calculated % crystallinity for polypropylene samples using: % Crystallinity for PP=((Hf)/165 J/g))×100. The heat of fusion (H_{f}) and the highest peak melting temperature are reported from the second heat curve. Highest peak crystallization temperature and onset crystallization temperature are determined from the cooling curve.

### Examples

The following examples illustrate features of the present disclosure but are not intended to limit the scope of the disclosure.

Polymers/Film Used

The following materials were included in the example laminates discussed below.

ELITE™ 5960G, an enhanced polyethylene resin having a density of 0.962 g/cm³ and melt index (I₂) of 0.85 g/10 min and commercially available from The Dow Chemical Company (Midland, Mich.).

ELITE™ 5960G1, an enhanced polyethylene resin having a density of 0.962 g/cm³ and melt index (I₂) of 0.85 g/10 min and commercially available from The Dow Chemical Company (Midland, Mich.).

ELITE™ 5940ST, an enhanced polyethylene resin having a density of 0.941 g/cm³ and melt index (I₂) of 0.8 g/10 min and commercially available from The Dow Chemical Company (Midland, Mich.).

ELITE™ 5400G, an enhanced polyethylene resin having a density of 0.916 g/cm³ and melt index (I₂) of 1.0 g/10 min and commercially available from The Dow Chemical Company (Midland, Mich.).

ELITE™ 5400GS, an enhanced polyethylene resin having a density of 0.916 g/cm³ and melt index (I₂) of 1.0 g/10 min and commercially available from The Dow Chemical Company (Midland, Mich.).

DOW™ LDPE 450E, a low density polyethylene resin having a density of 0.923 g/cm³ and melt index (I₂) of 2.0 g/10 min and commercially available from The Dow Chemical Company (Midland, Mich.).

BYNEL™ 41E710, an anhydride-modified, linear low density polyethylene resin having a density of 0.922 g/cm³ and melt index (I₂) of 2.7 g/10 min, and commercially available from The Dow Chemical Company (Midland, Mich.).

EVAL™ H171B, a 38 mol % ethylene vinyl alcohol copolymer having a density of 1.17 g/cm³ and melt index (I₂) of 1.7 g/10 min, and commercially available from Kuraray Co., Ltd. (Tokyo, Japan).

SURLYN™ 1707, an ionomer of ethylene acid copolymer neutralized with a sodium cation source, having a highest peak melting temperature (Tₘ) of 92° C., a density of 0.95 g/cm³ and melt index (I₂) of 0.9 g/10 min, and commercially available from The Dow Chemical Company (Midland, Mich.).

AFFINITY™ PF 7266, a polyethylene elastomer/plastomer having a highest peak melting temperature (Tₘ) of 76° C., a density of 0.885 g/cm³ and melt index (I₂) of 2.5 g/10 min, and commercially available from The Dow Chemical Company (Midland, Mich.).

ADCOTE™ 545S/Co-reactant F, a solvent based 2-component polyurethane adhesive commercially available from The Dow Chemical Company (Midland, Mich.).

INNATE™ ST70, a precision packaging resin having a density of 0.926 g/cm³ and melt index (I₂) of 0.85 g/10 min, and commercially available from The Dow Chemical Company (Midland, Mich.).

POLYBATCH® CE505, a slip masterbatch commercially available from Lyondell Basell (Houston, Tex.).

POLYBATCH® AB5, an antiblock masterbatch commercially available from Lyondell Basell (Houston, Tex.).

CONPOL™ 13B, an antiblock masterbatch commercially available from The Dow Chemical Company (Midland, Mich.).

CONPOL™ 20S1, a slip masterbatch commercially available from The Dow Chemical Company (Midland, Mich.).

TF-BOPE Substrate 20, a linear low density polyethylene, biaxially oriented film stretched by tenter frame in the machine direction at a draw ratio of 3-5× and in the cross direction at a draw ratio of 7-9× to a thickness of 20 microns. The linear low density polyethylene has a density of 0.926 g/cm³ and melt index (I₂) of 1.7 g/10 min, and is commercially available from The Dow Chemical Company, Midland, Mich., under the name INNATE™ XUS 59910.08.

TF-BOPE Substrate 40, a linear low density polyethylene, biaxially oriented film stretched by tenter frame in the machine direction at a draw ratio of 3-5× and in the cross direction at a draw ratio of 7-9× to a thickness of 40 microns. The linear low density polyethylene has a density of 0.926 g/cm³ and melt index (I₂) of 1.7 g/10 min, and is commercially available from The Dow Chemical Company, Midland, Mich., under the name INNATE™ XUS 59910.08.

MDO Substrate, a machine direction oriented multilayer, five layer polyethylene film having a thickness of 25 microns. The MDO Substrate comprises ELITE™ 5960G, ELITE™ 5940ST, INNATE™ ST70, and ELITE™ 5400GS.

HDPE Substrate, a multilayer, five layer film having 25 microns thickness and layer structure of (1) 100% ELITE™ 5960G1; (2) 100% ELITE™ 5960G1; (3) 100% ELITE™ 5960G1; (4) 100% ELITE™ 5960G1; (5) 100% DOW™ LDPE 450E. The film is created on a Collin 5-layer cast co-extrusion line with 4 extruders, Configuration: A/B/C/B/D; Layer Ratio: 1/1/1/1/1; melt temperature of each extruder of 250-260° C.; slot die by coat hanger geometry; total throughput of 8 kg/hr; line speed of 21.5 m/min.

BOPP Substrate, a printed biaxially oriented propylene film treated at 36 dynes and having an 18 micron gauge.

Laminates, designated as Inventive Examples 1-8 and Comparative Examples 1-2, are formed in a construction of PRINT-A-B-C-B-D, where “PRINT” corresponds to TF-BOPE Substrate 20, TF-BOPE Substrate 40, MDO Substrate, or HDPE Substrate for Inventive Examples or BOPP Substrate for Comparative Examples, and “A-B-C-B-D” corresponds to a five layer multilayer film. For each of the Examples, the “PRINT” substrate is laminated to the layer “A” of the multilayer film using ADCOTE™ 545S/Co-reactant F applied at a coating weight of 3-3.5 gsm. Examples are cured at room temperature (25° C.) for two days and a hot roll lamination process is performed on ChemInstruments #007416 at a temperature of 75° C., pressure of 60 psi, and speed of 1.66 m/min.

The five layer multilayer films for each of the Inventive and Comparative Examples is formed on a Collin 5-layer blown co-extrusion line with the following parameters—target film thickness: 55 μm; extruders: 4 extruders; layer configurations: A/B/C/B/D; layer ratio: 2/1.5/2/1.5/4; layer thickness (μm): 10/7.5/10/7.5/20; die diameter (mm): 50; blow up ratio (BUR): 3.0; layflat width (mm): 235; total throughput of 8 kg/hr; line speed of 5.4 m/min; melt temperature (° C.) of extruders A, B, C, and D of 174° C., 191° C., 197° C., and 177° C., respectively.

Table 1 below provides the structure and composition of the laminate examples, Inventive Examples 1-8 and Comparative Examples 1-2.

TABLE 1
Laminate Structure and Composition

| Example | Print | Layer A | Layer B | Layer C | Layer B | Layer D |
|---|---|---|---|---|---|---|
| Comp. 1 | BOPP | DOW ™ | 50% BYNEL ™ | EVAL ™ H171B | 50% BYNEL ™ | 80% AFFINITY ™ |
| | Substrate | LDPE 450E | 41E710 + 50% | | 41E710 + 50% | PF 7266* |
| | | | ELITE ™ 5960G1 | | ELITE ™ 5960G1 | |
| Comp. 2 | BOPP | DOW ™ | 50% BYNEL ™ | EVAL ™ H171B | 50% BYNEL ™ | 93.5% SURLYN ™ |
| | Substrate | LDPE 450E | 41E710 + 50% | | 41E710 + 50% | 1707** |
| | | | ELITE ™ 5960G1 | | ELITE ™ 5960G1 | |
| Inv. 1 | TF-BOPE | DOW ™ | 50% BYNEL ™ | EVAL ™ H171B | 50% BYNEL ™ | 80% AFFINITY ™ |
| | Substrate 40 | LDPE 450E | 41E710 + 50% | | 41E710 + 50% | PF 7266* |
| | | | ELITE ™ 5960G1 | | ELITE ™ 5960G1 | |
| Inv. 2 | TF-BOPE | DOW ™ | 50% BYNEL ™ | EVAL ™ H171B | 50% BYNEL ™ | 93.5% SURLYN ™ |
| | Substrate 40 | LDPE 450E | 41E710 + 50% | | 41E710 + 50% | 1707** |
| | | | ELITE ™ 5960G1 | | ELITE ™ 5960G1 | |
| Inv. 3 | TF-BOPE | DOW ™ | 50% BYNEL ™ | EVAL ™ H171B | 50% BYNEL ™ | 80% AFFINITY ™ |
| | Substrate 20 | LDPE 450E | 41E710 + 50% | | 41E710 + 50% | PF 7266* |
| | | | ELITE ™ 5960G1 | | ELITE ™ 5960G1 | |
| Inv. 4 | TF-BOPE | DOW ™ | 50% BYNEL ™ | EVAL ™ H171B | 50% BYNEL ™ | 93.5% SURLYN ™ |
| | Substrate 20 | LDPE 450E | 41E710 + 50% | | 41E710 + 50% | 1707** |
| | | | ELITE ™ 5960G1 | | ELITE ™ 5960G1 | |
| Inv. 5 | HDPE | DOW ™ | 50% BYNEL ™ | EVAL ™ H171B | 50% BYNEL ™ | 80% AFFINITY ™ |
| | Substrate | LDPE 450E | 41E710 + 50% | | 41E710 + 50% | PF 7266* |
| | | | ELITE ™ 5960G1 | | ELITE ™ 5960G1 | |
| Inv. 6 | HDPE | DOW ™ | 50% BYNEL ™ | EVAL ™ H171B | 50% BYNEL ™ | 93.5% SURLYN ™ |
| | Substrate | LDPE 450E | 41E710 + 50% | | 41E710 + 50% | 1707** |
| | | | ELITE ™ 5960G1 | | ELITE ™ 5960G1 | |
| Inv. 7 | MDO | DOW ™ | 50% BYNEL ™ | EVAL ™ H171B | 50% BYNEL ™ | 80% AFFINITY ™ |
| | Substrate | LDPE 450E | 41E710 + 50% | | 41E710 + 50% | PF 7266* |
| | | | ELITE ™ 5960G1 | | ELITE ™ 5960G1 | |
| Inv. 8 | MDO | DOW ™ | 50% BYNEL ™ | EVAL ™ H171B | 50% BYNEL ™ | 93.5% SURLYN ™ |
| | Substrate | LDPE 450E | 41E710 + 50% | | 41E710 + 50% | 1707** |
| | | | ELITE ™ 5960G1 | | ELITE ™ 5960G1 | |

*In addition to 80% AFFINITY ™ PF 7266, Layer D includes 10% POLYBATCH ® CE505 and 10% POLYBATCH ® AB5.
**In addition to 93.5% SURLYN ™ 1707, Layer D includes 4% CONPOL ™ 13B and 2.5% CONPOL ™ 20S1.

The thickness, oxygen transmission rate (OTR), and water vapor transmission rate (WVTR) of the examples are measured. Table 2 provides the results. Laminates having a BOPP Substrate are known to exhibit slightly better WVTR properties than comparable polyethylene laminates. Comparative Examples 1 and 2, which contain a print BOPP Substrate, are not compatible with polyethylene recycling streams, although they perform comparable or better with OTR and WVTR than Inventive Examples 1 to 8. A person of ordinary skill in the art will appreciate that the OTR of the laminate can be adjusted depending on the thickness and ethylene content of the EVOH of the barrier layer (i.e., in general, the thicker the barrier layer or the lower the ethylene content, the lower the achievable OTR value is). As noted above, the Inventive Examples are nonlimiting examples, not intended to limit the scope of the disclosure, and a multilayer film according to embodiments of the present invention can include a barrier layer comprising an EVOH having an ethylene content of from 20 to 50 mol %.

TABLE 2
Thickness, OTR, and WVTR

| | Thickness | OTR | WVTR |
|---|---|---|---|
| Example | (μm) | (cm³/day/m²) | (g/day/m²) |
| Comp. 1 | 73 | 2.68 | 2.85 |
| Comp. 2 | 73 | 1.82 | 2.49 |
| Inv. 1 | 95 | 0.42 | 3.19 |
| Inv. 2 | 95 | 1.56 | 3.27 |
| Inv. 3 | 75 | 2.37 | 4.06 |
| Inv. 4 | 75 | 2.15 | 4.01 |
| Inv. 5 | 80 | 2.05 | 3.15 |
| Inv. 6 | 80 | 2.00 | 2.83 |
| Inv. 7 | 80 | 2.00 | 4.42 |
| Inv. 8 | 80 | 6.51 | 2.69 |

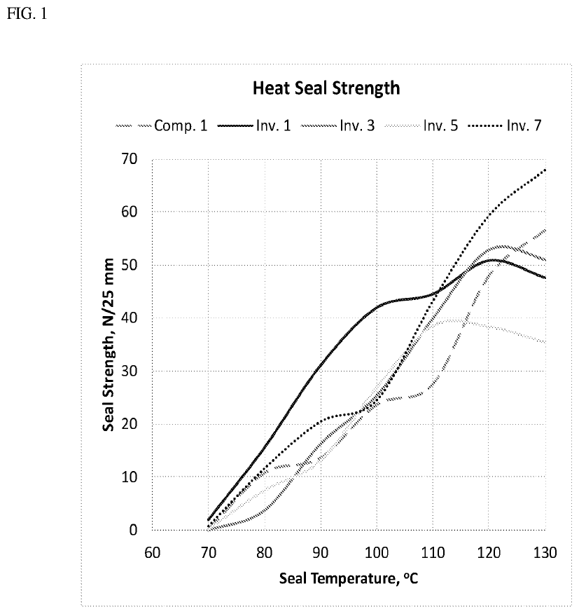

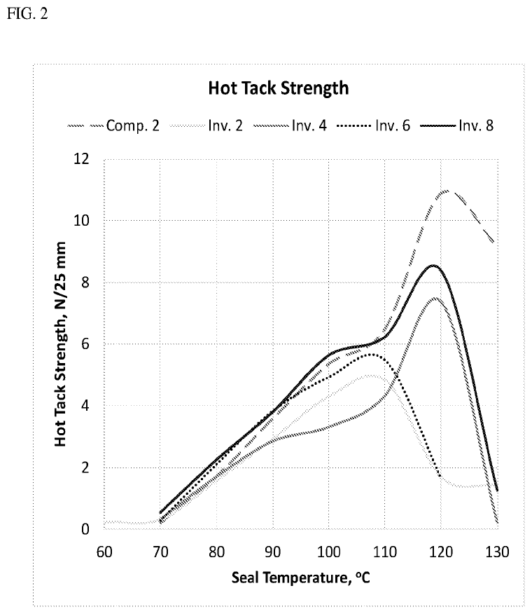

The heat seal initiation temperature (HSIT), seal strength, hot tack initiation temperature at 1 Newton, and hot tack strength at 110° C. are measured. FIG. 1 shows the heat seal strength curves of Comparative Example 1 and Inventive Examples 1, 3, 5, and 7. FIG. 2 shows the hot tack strength curves of Comparative Example 2 and Inventive Examples 2, 4, 6, and 8. Tables 3 and 4 provide the results. The shrinkage (%) at 70° C., 80° C., 90° C., 100° C., 110° C., 120° C., and 130° C. of the examples is measured. None of the examples show shrinkage at 70° C., 80° C., 90° C., 100° C., or 110° C. in the machine direction (MD) or cross or transverse direction (TD). The results of shrinkage (%) between 70° C. and 130° C. for the examples are reported in Table 5.

Inventive Examples 1, 3, 5, and 7 have comparable or in aspects improved HSIT, seal strength, hot tack initiation, and hot tack strength in comparison to Comparative Example 1. Likewise, Inventive Examples 2, 4, 6, and 8 have comparable or in aspects improved HSIT, seal strength, hot tack initiation, and hot tack strength in comparison to Comparative Example 2. The Inventive Examples show a desirable or maintained low hot tack initiation temperature and low HSIT and achieve in aspects maintained or improved seal strength performance. The Inventive Examples have comparable heat resistance and seal performance to the Comparative Examples in the temperature range of from 70° C. to at least 120° C., and so have a sealing window of at least 40° C., or around 50° C.

TABLE 3
HSIT, Seal Strength, Hot Tack Initiation, and Hot Tack Strength
for Comparative Example 1 and Inventive Examples 1, 3, 5 and 7.

| | | Seal | | Hot Tack |
|---|---|---|---|---|
| | | Strength @ | Hot Tack | Strength @ |
| | HSIT @ 5N | 120° C. | Initiation @ 1N | 110° C. |
| Example | (° C.) | (N/25 mm) | (° C.) | (N/25 mm) |
| Comp. 1 | 74 | 47.9 | 78 | 1.51 |
| Inv. 1 | 74 | 50.8 | 82 | 1.23 |
| Inv. 3 | 81 | 52.8 | 79 | 1.31 |
| Inv. 5 | 76 | 38.4 | 78 | 0.35 |
| Inv. 7 | 74 | 59.3 | 75 | 2.13 |

TABLE 4
HSIT, Seal Strength, Hot Tack Initiation, and Hot Tack Strength
for Comparative Example 2 and Inventive Examples 2, 4, 6 and 8.

| | | Seal | | Hot Tack |
|---|---|---|---|---|
| | | Strength @ | Hot Tack | Strength @ |
| | HSIT @ 5N | 120° C. | Initiation @ 1N | 110° C. |
| Example | (° C.) | (N/25 mm) | (° C.) | (N/25 mm) |
| Comp. 2 | 97 | 12.2 | 75 | 6.43 |
| Inv. 2 | 95 | 13.2 | 75 | 4.84 |
| Inv. 4 | 96 | 11.0 | 75 | 4.33 |
| Inv. 6 | 95 | 12.2 | 74 | 5.27 |
| Inv. 8 | 96 | 10.6 | 73 | 6.23 |

TABLE 5
Shrinkage (%) between 70 and 130° C. within the heat sealing window

| | Shrinkage (%) | Shrinkage (%) | Shrinkage (%) | Shrinkage (%) | Shrinkage (%) | Shrinkage (%) |
|---|---|---|---|---|---|---|
| | in MD @ | in TD @ | in MD @ | in TD @ | in MD @ | in TD @ |
| Example | 70-110° C.* | 70-110° C.* | 120° C.* | 120° C.* | 130° C.* | 130° C.* |
| Comp. 1 | 0 | 0 | 0 | 0 | 0 | 0 |
| Comp. 2 | 0 | 0 | 0 | 0 | 0 | 0 |
| Inv. 1 | 0 | 0 | >8 | 4 | >12 | 12 |
| Inv. 2 | 0 | 0 | >8 | 4 | >12 | 12 |
| Inv. 3 | 0 | 0 | >8 | 8 | >12 | 4 |
| Inv. 4 | 0 | 0 | >8 | 4 | >12 | 8 |
| Inv. 5 | 0 | 0 | 0 | 0 | 0 | 0 |
| Inv. 6 | 0 | 0 | 0 | 0 | 0 | 0 |
| Inv. 7 | 0 | 0 | 0 | 0 | 0 | 0 |
| Inv. 8 | 0 | 0 | 0 | 0 | 0 | 0 |

*Seal bar dimensions: 0.5 cm (MD direction) × 2.5 cm (TD direction).

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A laminate comprising:
(a) a multilayer film comprising:
(1) a barrier layer comprising ethylene vinyl alcohol copolymer;
(2) a sealant layer, wherein the sealant layer comprises at least 70 wt. % of an ionomer of ethylene acid copolymer or polyethylene elastomer/plastomer having a highest peak melting temperature (Tₘ) of 100° C. or less; and
(3) a tie layer between the barrier layer and the sealant layer;
(b) a polyethylene film comprising an ethylene-based polymer having a density from 0.900 to 0.970 g/cm³; and
(c) an adhesive adhering the multilayer film to the polyethylene film.

2. The laminate of claim 1, wherein the multilayer film further comprises an outer layer comprising a polyethylene having a density of from 0.900 to 0.970 g/cm³ and a second tie layer between the outer layer and the barrier layer.

3. The laminate of claim 1, wherein the polyethylene film is an oriented film.

4. The laminate of claim 1, wherein the polyethylene film is a biaxially oriented film.

5. The laminate of claim 1, wherein the polyethylene film is a machine direction oriented film.

6. The laminate of claim 1, wherein the polyethylene film further comprises at least 20 wt. % of a second ethylene-based polymer having a density of 0.958 g/cm³ or greater.

7. The laminate of claim 1, wherein the polyethylene film further comprises a barrier layer comprising an ethylene vinyl alcohol copolymer.

8. The laminate of claim 1, wherein the barrier layer of the multilayer film is 5 to 25% of overall thickness of the multilayer film.

9. The laminate of claim 1, wherein the sealant layer is at least 10 microns thick.

10. The laminate of claim 1, wherein the sealant layer is 25 to 60% of overall thickness of the multilayer film.

11. The laminate of claim 1, wherein the tie layer comprises an anhydride-modified, linear low density polyethylene and at least one of a linear low density polyethylene, low density polyethylene, medium density polyethylene, or high density polyethylene.

12. The laminate of claim 1, wherein the adhesive comprises a solvent based adhesive, solvent-free adhesive, or water-borne adhesive.
